(19) United States
(12) Patent Application Publication
(10) Pub. No.: US 2003/0116704 A1
(43) Pub. Date: Jun. 26, 2003

(54) Apparatus and method for controlling the spatial beam position of laser beams and an actuator for use with this apparatus and method

(76) Inventor: Thomas Mueller-Wirts, Hannover (DE)

Correspondence Address: Karl F. Milde, Jr., Esq., MILDE & HOFFBERG, L.L.P., Suite 460, 10 Bank Street, White Plains, NY, 10606, US

(21) Appl. No.: 10/307,006

(22) Filed: Nov. 26, 2002

(30) Foreign Application Priority Data
Dec. 21, 2001 (EP) 01130721.2

(51) Int. Cl. H01J 3/14; H01J 5/16; H01J 40/14; B41J 15/14; B41J 27/00; H04N 1/04

(52) U.S. Cl. 250/235; 347/241; 358/474

(57) ABSTRACT

Apparatus and method are disclosed for controlling the spatial beam position of laser beams, e.g., in a laser exposure device, using a position detector for determining the current (actual), beam position and a control element for determining the control quantity based on the difference between the actual and the desired beam position. An actuator that moves an optical element, which in turn guides the laser beam, is provided for changing the beam position. The actuator includes a controllable heating element that is connected to a position-determining actuator element, for moving the actuator element and, thus, the optical element, through thermal expansion due to heating of the actuator element.

### BACKGROUND OF THE INVENTION

The present invention relates to an apparatus and a method for controlling the spacial beam position of laser beams, and an actuator for use with this apparatus and method, which allows the position of laser beams to be corrected, if necessary, so that they remain stable over an extended period of time.

In the field of photographic paper and film exposure as well as in many other fields related to technical optics, it is necessary to maintain laser beams at their beam position in space with a high degree of accuracy over long periods of time. Interfering with this objective are, in particular, thermal drifts of both the laser and the beam-conducting optics and mechanics. But even mechanical connections such as screw connections and adhesive bonds show drift effects: Screw connections may cause permanent maladjustments caused by strong acceleration forces and temperature fluctuations (e.g., when transporting a unit). Adhesive bonds may show drift or flow occurrences even after weeks or years if a polymerization process was not completely finished. Furthermore, sensitive compromises must be established with adhesive bonds between an elastic bond that is less sensitive to temperature fluctuations and impact loads of the bonded elements, and a “hard” mechanically reproducible bonds that avoid the requirement for optical readjustments.

Through the given constraints, such as the available materials, the spatial dimensions and, not unimportantly, the financial framework and limitations of development and manufacturing, a sufficient mechanical reproducibility and an ability to overcome drift can not always be ensured. In such cases, active beam position stabilization can present a good, and potentially inexpensive solution.

Such a solution often requires the capability of influencing the beam position through suitable actuators that can either move optical components such as mirrors, lenses, etc. in a suitable manner or influence their optical properties. In addition, a sensor unit is required that can sense the undesired influences of changes to the beam position. The sensor signals so obtained are provided to a control unit that uses (often electrical) control parameters and actuators to return beams to their desired nominal position.

Such beam position stabilization is known, for example, from the U.S. Pat. No. 6,236,040. In this case two laser beams in an electro-photographic or other laser exposure device are to be kept at a constant distance from one another. This is done by determining the actual positions of the laser beams using monitoring elements, comparing the measured positions to one another in order to determine the current distance and, if deviations of this distance from the desired distance are detected, correcting the laser position using optical elements that are located in the beam path of the laser. The optical elements are moved using linear step motors.

This method has a disadvantage, however, in that when using simple step motors, only concrete adjustment steps of the laser beam are possible, which does not allow for very precise positioning of the laser beam.

If, on the other hand, very precise step motors are used that allow very small increments, the system becomes very expensive and complex.

For this reason, attempts have been made to design the lasers such that beam position stabilization is not necessary. However, this requires a significant effort to improve the mechanical long-term stability of the optical structure of the laser exposure unit. It might be necessary to make critical compromises between mechanical properties such as damping, weight, size, machinability of the used materials and, in particular, the manufacturing cost, in favor of the thermal expansion properties. The required precise adjustments of an optical instrument on location through trained personnel also presents a significant disadvantage. Even during the manufacturing process of the instrument, the costs of precision mechanisms as well as for the associated time expenditure for precise adjustments may definitely play a major role. For this reason, it is often not a suitable solution to select a very stable laser; rather it would be more sensible to employ a more inexpensive laser and carry out suitable beam position stabilization.

In particular in the field of photo laser exposure devices, such beam position stabilization is of particular interest, since extremely high requirements are placed on the stability of laser beams in these cases. When exposing photographic data onto light-sensitive material, it is necessary to ensure the congruence of the beam positions of three laser beams with different wavelengths (red, green and blue), which are combined using beam combiners, dependably for the life expectancy of the exposure devices, possibly without the need for manual adjustment. Typical demands on the beam position stability of the lasers used for such an application (for the so-called “beam pointing”) are high and are essentially not met, or met only with compromises, by the lasers on the market today. Spatial short-time stability, noise properties, wavelength stability and some other properties are sufficiently controlled. However, the drift of the pointing due to influences of the surrounding temperature continues to be a problem.

Although it is possible to provide complete thermal stabilization of the entire structure, with justifiable expenditures this is successful only to a certain degree. Furthermore, relatively large electrical energies are dissipated due to the lasers and modulators that are being used, such that inconsistent temperature gradients build up in the unit that influence the beam position stability in a very negative way. This also prevents massive hermetic sealing as would be possible with “passive” non-heat-dissipating units. Although an increase in the mechanical rigidity and of the mass would reduce the influence of the temperature gradients, it might, however, increase the time to achieve a thermal balance to an unacceptable degree.

### SUMMARY OF THE INVENTION

It is, therefore, a principal objective of the present invention to allow, without manual intervention, for an adjustment of, or for, the fixing of the beam position of a laser beam within a narrow, tolerated range, or to enable the congruence of the beam positions of several laser beams that are combined using beam combiners, in a reliable manner over an extended period of time. A further objective of the present invention is to enable or facilitate the manufacture of very simple and inexpensive actuators for implementing this principal objective.

These objectives, as well as further objectives which will become apparent from the discussion that follows, are achieved, in accordance with the present invention, by apparatus, a method and an actuator which changes the beam position by controlled thermal expansion of at least one position-adjusting (position determining) actuator element.

Precise positioning of the laser is accomplished based on a value derived from the difference between the current beam position and the nominal value using a thermal actuator. According to the invention, a particularly simple actuator is suggested that can be manufactured inexpensively yet can be operated with high precision. Such a thermal actuator exhibits a controllable heating element, which is in contact with actuation elements that are responsible for the movement of the actuator. In its simplest form, this heating element may be a current source that is connected with actuation elements that have current flowing through them. By controlling the current that flows through the actuator elements that are to be moved, targeted heating of these elements can be achieved. This very simple primary heating method allows for a very simple and compact structure of the actuator, because the moving elements for determining position are at the same time the elements to be heated. Since the drift of the laser beams is caused particularly by thermal effects, it is particularly advantageous to counteract such drifts with thermal correction means, that is, through thermal actuators, since the principle for cause and solution are based on the same functionality, i.e., they are affected by the same time scale, the same environmental influences, etc.

Furthermore, a particularly advantageous, compact and simple structure can be achieved in that these position-determining elements also constitute the carrying elements that are used for the stabilization of the optical elements. Particularly well suited as position-determining elements are, in this case, steel pins or steel wires, for example made of stainless steel or spring steel, since such materials exhibit a very high specific electrical resistance and comparatively great mechanical strength and elasticity. In addition, stainless steel can be brought to high temperatures without being adversely affected by oxidation. These materials are preferred over other conductive materials such as copper, brass or aluminum, although the latter materials may be employed as well.

However, with such a structure, a compromise must be found between stability and maximum possible deflection of the actuator, since a greater stability can be achieved in particular through a greater diameter of the position-determining conductor elements. A greater diameter, however, requires significantly greater electrical power for heating due to the greater surface and higher heat diffusion. Too much additional heating of the device by the electrical power supplied to the actuator is, however, generally undesirable and limits the achievable effective range. Thus, such an actuator is particularly advantageous only when small optical elements are to be moved, the device is essentially not subject to vibrations and there is no room for larger actuators in the unit. These prerequisites are met in many photographic laser exposure devices; if the actuator is to be used for fiber coupling, however, this is often not the case.

It is, therefore, often advantageous to use secondary heating instead of this primary heating. With that, an independent heating element is applied to the position-determining—and possibly also static, i.e., carrying element—of the actuator. Although this design variation does not allow for as simple a structure as the primary heating, the aforesaid compromises between a justifiable amperage and mechanical stability do not need to be made. The carrying and position-determining elements may be made of aluminum, for example, or of any other material that exhibits a very high thermal coefficient of expansion and at the same time great mechanical strength and good machinability. Electrical resistors that are available in a great variety and allow for an optimum adaptation to the required power and a simple electrical control can be used as heating elements. Since the supporting elements can often have a small design, the heating power achievable with simple SMD resistors may be sufficient.

An additional option of secondary heating is to apply heating elements on mechanical components that are already present in the device at a suitable location in order to achieve a sufficient influence on the beam position and thus to convert the use of the mechanical components to actuators. However, it must be observed that no uncontrolled actuator movement or too slow or too small a movement occurs or that the applied thermal power disturbs the system. In general, this solution is rather discouraged since it is not so easy to affect a regulated control.

In a particularly advantageous and space-saving embodiment of the actuator, the position-determining, thermally expandable actuator elements are also the elements that carry a carrier element for the optical elements. This embodiment is particularly advantageous, when the demands on stability are not so high but the actuator needs to be built small for reasons of space. With this embodiment, the thermal expansion of the position-determining actuator elements induced by the heating is directly converted into a movement of the carrier element, and thus, of the optical elements.

Since the coefficients of thermal expansion of the materials in question are relatively small for many applications, and for stability and space reasons an unnecessary size is not desired, transmission mechanisms that transform small movements into a bigger ones suggest themselves. In the simplest form, actuators may act upon the element to be moved via a mechanical lever that fulfills this task. An example for this is presented using the exemplary embodiment of FIG. 2.

An additional possibility consists in providing the actuator with a position-determining actuator element for movement and an additional, static actuator element, where these actuator elements are arranged relative to one another such that the desired direction of movement does not occur in the direction of expansion of the position-determining actuator element, but instead in a more or less large angle to it. Arrangements may be selected, for example, where the points of the acting force represent triangles, especially with an acute angle. An example for this is shown in FIG. 3. Since in this case position-determining and static actuator elements are essentially arranged in triangular shapes, this type of force transmission may also be called trigonometric transmission. For example, if one side of a triangle with an acute angle 9 is elongated by a distance Δx, then the tip of the triangle moves in rough approximation by about Δy=Δx 1/tan φ, perpendicular to the elongation.

Thus, in principle, very large movements can be achieved with very small angles. However, limits are set by the strength of the materials in use on one hand and by the required forces at the moved object on the other hand. The required static forces for moving a small and light optical component may be very small; however, great demands on the rigidity of the suspension and thus on the size of the dynamic forces may exist due to vibrations of the device.

Particularly when using primary heating, the demands on the actuator stroke on the one hand and on the rigidity on the other hand often do not allow for a suitable compromise, since with the required actuator stroke the rigidity would be so poor that the system could be too susceptible to vibration for the application. In such a case, operating several actuator elements in parallel may be recommended. In case of primary heating, these elements may be switched in series electrically, but switched in parallel mechanically.

In comparison to an actuator consisting of one single actuator element or element pair, the stroke force and the strength are increased when using several actuator elements mechanically switched in parallel with the same stroke.

In a particularly advantageous embodiment, several actuator elements can be moved independently of one another or in opposite directions. This can be realized, for example, in that several position-determining actuator elements are each connected with an independent heating element or can be controlled independently of one another from a heating element.

With primary heating, this may be realized through a power source that is connected with the position-determining actuator elements via one control each. The inserted control enables the different operations of the actuator elements. Such a structure enables the performance of multi-dimensional movements of the carrier elements, and therefore, of the optical elements. In this manner, laser beams can be deflected in various directions, or stabilized; with conventional actuators, this can be realized only by using several actuators in one beam path. Actuators subject to the invention are, therefore, ideally suited for implementing multi-dimensional actuators, because the basic design with extendable position-determining, heatable actuator elements can be expanded rather easily and to any number of actuator elements. This is a particular cost-advantage over conventional actuators, because a multi-dimensional actuator is, of course, significantly less expensive than several actuators that move only in one dimension with each requiring its own control and activation element.

In particular, the requirements for activation are significantly lower with the actuators subject to the invention making it less expensive than, for example, piezo actuators. Contrary to the piezo actuator control, no high voltages are required but rather—especially with primary heating—high currents and very low voltages. Through the low resistance of mechanically carrying actuator elements with a larger cross-section, currents of several amps may be required. (The voltage drop at the heating element is, however, very small and thus the wattage very small as well). With secondary heating on the other hand, an optimum adaptation to the given electrical supply can be achieved through the appropriate selection of the electrical resistance of the heating element. For many applications, the required heating power is in a range below 100 mW. With typical supply voltages of 5 to 15 volts, the required currents are then in a range of a few 10 mA, which can be supplied by the operational amplifiers currently in use, even without driver stages. Since, for example, a bipolar power source shows no advantage, due to the square function, the output stage driving the heating element can be designed in a very simple fashion, even if higher currents are required. In the simplest case, it consists of a power transistor, since even linearity is not required for the driver stage. If high currents with low voltages are needed, a current driver stage is preferred over a voltage driver stage, also with regard to short-circuit strength without additional circuit expenditure. Because thermal actuators by nature operate relatively slowly, switching drivers is an option as well, if it can be ensured that the switched currents do not interfere with other parts of the circuit.

A particularly advantageous design of an actuator is proposed in order to definitively correct all possible directions of movement that a laser beam may drift to. This is based on the arrangement of three linear actuators in a tetrahedron. They allow for any three-dimensional translation of a point in space. However, an actual object to be moved also has the possibility of rotation around three spatial axes that generally must be guided sufficiently as well. If respective tetrahedron devices that are each operated parallel to one another now support this object, then the object can carry out any translation in the space, however, without rotation. If, however, the tetrahedrons are controlled independently of one another, then the object can additionally carry out all rotational movements as well.

With a more correct analysis of the directions of action, it will be realized that the definition of certain degrees of freedom is partially redundant through the actuator elements and that, with a suitable orientation, one actuator each of each tetrahedron can be removed; that is, only six actuators can be used instead of nine.

Such an arrangement is known under the name “hexapod”. The number of six actuators corresponds exactly to the total number of three translational and three rotational degrees of freedom. However, each actuator does not correspond to exactly one degree of freedom. Instead, the actuators must perform a combination movement that requires complex computations in order to carry out the movement of one degree of freedom.

With the concept recommended here, the actuator elements consist, in the simplest case, of conductors carrying currents—that is, for example, of small wire sections that are heated using controlled currents—and thus enable very small, lightweight actuators for almost no cost. In addition, they can be used as mechanically carrying elements and thus can replace additional otherwise required structural elements. These current-conducting actuator elements can be combined with simple standard printed circuit boards as a base plate and carrier element. In their standard version, they are already manufactured of fiberglass-enforced epoxy resin, which exhibits low weight, high strength, a good long-term stability and high rigidity. In particular, the necessary electrical connections of the actuators, among each other and to the connectors, can be designed in a simple manner using standard PC-board technologies and can be manufactured at very little cost. With a suitable design, even the assembly of the actuators can be done using standard component mounting technologies. (If the requirements for the rigidity of the PC-board material are higher, ceramic PC-board material may be used.) In this manner (and due to the simplicity of control with very low voltages and currents) active stabilizations devices be manufactured very inexpensively. Thus, the realization of hexapods or similar designs with these simple, inexpensive thermal actuators suggests itself.

With one method according to the invention, where laser beams need to be accurately aligned, the current position of the beams is determined and compared to the aspired nominal value of the beam position. If a deviation is encountered, a determination is made by how much the beam position of the laser beam must be corrected. This correction is carried out using optical elements such as lenses, mirrors or plane-parallel plates, etc., that are moved using a thermal actuator by expanding (or contracting) position-determining actuator elements through heating (or cooling). Heating (or cooling) is carried out in a controlled manner such that any desired expansion (or contraction) and, thus, any even very small movement can be realized in a targeted manner. This allows for high-precision positioning of the laser beams.

One advantageous way of carrying out the heating of the position-determining actuator elements consists of the use of conducting elements with a controllable current flowing through them. These actuator elements expand more or less, depending upon the current quantity, affecting a movement of optical elements that are in contact with these actuator elements. This design is particularly inexpensive because it does not require external heating elements; the actuator elements themselves are the heating elements.

However, since in this case an essentially efficient expansion of the position-determining actuator elements and at the same time stability of the actuator may be hard to achieve, it is often more advantageous for applications, where stability is a priority, to bring the position-determining actuator elements into contact with heating elements having a greater efficiency factor for causing the expansion.

An actuator according to the invention for controlling the beam position of laser beams includes carrier elements for the beam-deflecting optical elements as well as actuator elements that are in contact with the carrier elements and that are at least partially in connection with a controllable heating element. The actuator elements that are connected to the controllable heating element are thermally changeable in their expansion. The carrier element and, thus, the optical element attached to it are moved through the change of the thermal expansion of these position-determining actuator elements. In addition to the thermally expandable elements, the actuator also includes static actuator elements that are also connected to the carrier elements and that are needed for increased stability of the actuator. In a respective advantageous arrangement, it is also possible to design all actuator elements to be thermally expandable such that position-determining actuator elements are at the same time static actuator elements. However, in this case, compromises must be made between the heating power required for the expansion and the stability of the actuator. Thus, if the actuator requires certain stability, it is advantageous to use separate position-determining and static actuator elements. On the other hand, if the actuator is to be designed as compact as possible, it is more advantageous to use only thermal actuator elements.

It is particularly advantageous to arrange position-determining and static actuator elements in triangular fashion (or at least in a manner similar to triangles, in other words at an angle to one another but also at a certain distance to one another) where the angle between the elements is less than 45°. This accomplishes a mechanical transmission of the expansion of the position-determining actuator element.

A particularly advantageous embodiment provides the selection of an angle of less than 20° between the position-determining and the static actuator elements. The smaller an angle is selected, the more advantageous such a transmission will be. However, this sets stability limits because triangles with a more acute angle have a less stable base for the carrier element than actuator elements that are further apart from one another.

This loss in stability may be advantageously canceled by using several position-determining and/or several static actuator elements that are arranged parallel to one another. The use of several actuator elements results in both a greater stroke force and a greater stability of the system. It is additionally possible to move the actuator elements independently of one another, which ensures that the actuator can be moved in many spatial directions. In this manner, multi-dimensional actuators can be implemented and the laser beam can be deflected in any direction corresponding to the design and arrangement of the position-determining elements, which for conventional one-dimensionally movable actuators is possible only by using several actuators.

A particularly advantageous arrangement of the actuator elements is in the shape of a tetrahedron. A tetrahedron arrangement allows for any three-dimensional translation and, thus, deflections of the laser beam in three spatial directions. The use of several of these tetrahedron arrangements results in very movable, multi-dimensional and relatively stable actuators.

A particularly advantageous advancement of this tetrahedron arrangement is a hexapod, which consists in the use of three tetrahedron arrangements in order to hold and move a carrier element, where one actuator element each is removed from the tetrahedrons and the remaining actuator elements are connected to one another. With this design, it is possible to carry out movements in all three spatial directions without the need to deal with undesirable rotations.

The invention is not limited to these examples because any combinations can be implemented in sub-groups of actuators when using such arrangements of actuator elements. Octapod or multipod arrangements can be imagined.

A particularly advantageous embodiment consists in that the position-determining and static actuator elements are realized through the use of steel pins, where the position-determining elements are connected to a power source such that they can be heated as conductors carrying electricity, which in turn provides the desired expansion. This embodiment can be manufactured easily and at low cost. PC-boards are advantageously used as carrier elements. They exhibit the required rigidity, can be easily connected to the steel pins and are also acquired inexpensively.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic presentation of a laser exposure device using actuators according to the invention.

FIG. 2 shows an actuator according to the invention with a mechanical lever connection.

FIG. 3 shows an actuator according to the invention with a trigonometric connection.

FIG. 4 shows an actuator according to the invention with several position-determining and static elements.

FIG. 5 shows another actuator according to the invention with several position-determining and several static elements.

FIG. 6 shows an actuator according to the present invention whose elements exhibit a tetrahedron arrangement.

FIG. 7 shows an actuator according to the invention that is constructed of several actuator sub-units in tetrahedron arrangement.

FIG. 8 shows an actuator according to the invention whose elements are arranged in hexapod fashion.

FIGS. 9 and 10 show actuators according to the invention whose elements are arranged in octapod fashion.

FIG. 11 shows an actuator according to the invention for beam position adjustment using an optical lens moved two-dimensionally.

### DETAILED DESCRIPTION OF THE PREFERRED EMBODIMENTS

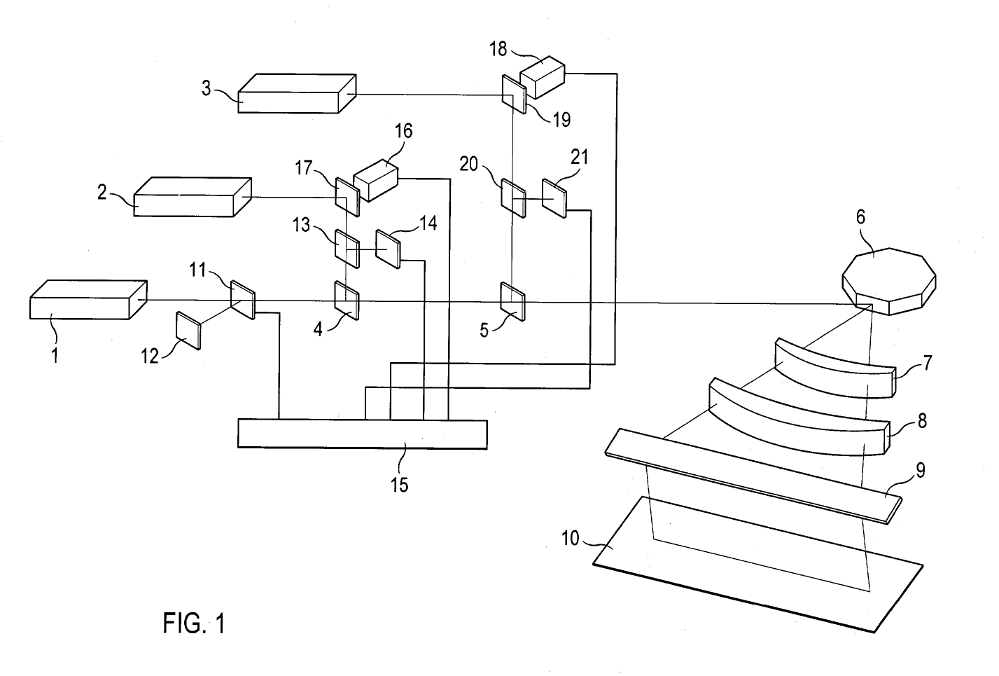

The preferred embodiments of the present invention will now be described with reference to FIGS. 1-11 of the drawings. Identical elements in the various figures are designated with the same reference numerals.

FIG. 1 shows a laser exposure device that is constructed of several laser beams. This may be a printer with multi-color lasers or a single-color laser exposure device that uses several laser beams of the same kind to increase the light intensity, and thus speed up the exposure. The laser beams are emitted by the laser sources 1, 2 and 3. They are combined into one light path by beam combiners 4 and 5 that consist, for example, of dichroic mirrors. The combined laser beam strikes a polygon mirror 6 and is deflected from the facets of this polygon mirror to two lenses 7 and 8. The two lenses 7 and 8 image the laser beam onto a mirror 9 from which the beam is directed to light-sensitive material 10. Depending upon the type of laser exposure device, the light-sensitive material can be photographic paper; however, it may also be thermographic or any other suitable material.

With such laser exposure devices, it is particularly important for the image quality to precisely place the several laser beams on top of one another, such that no color fringes are created when writing a line with different color lasers, for example. For this reason, a portion of the first laser beam is directed via a beam splitter 11 to a position sensor 12, in order to accurately determine the beam position of the first laser beam, for example, the red one. The beam position of the second, for example, blue laser beam must now be brought to precise agreement with the beam position of the first laser beam. For this purpose, the laser beam 2 is partially directed to an additional position sensor 14 via a beam splitter 13. The position sensor 14 determines the current position of the laser beam 2 and provides this information to a control element 15, to which the first position sensor 12 has already supplied the beam position of the first laser beam. The two beam positions are compared at this control element and, in the case where a deviation a control quantity is determined, which is a measure for how much the position of the laser beam 2 must be changed to ensure congruence of the beam positions. This control quantity is transferred to a thermal actuator 16 that is connected to a mirror 17, where the laser beam 2 is reflected. If the position of the laser beam 2 must be changed, a (not shown) heating element is controlled correspondingly, position-determining actuator elements in the actuator 16 expand, and the mirror 17 moves such that the laser beam 2 is reflected in a slightly changed angle, which influences its beam position. Using a control device, this beam position is continuously monitored, the current beam position is again compared at the control element 15 and if congruence with the laser beam 1 is still not achieved, further beam repositioning occurs via the thermal actuator. According to the same method, the beam position of an additional, for example green, beam emitted by the laser source 3 is brought to agreement with the spatial beam position of laser beams 1 and 2. This laser beam is also changed in its beam position using a thermal actuator 18 that moves a mirror 19 for positioning. The current beam position is also determined by guiding a portion of the laser beam via a partially transmitting beam splitter 20 to a detector 21. This beam position is transmitted to the control element 15 as well, where all three spatial beam positions are combined in order to determine adjustment quantities for the thermal actuators and their moved optical elements.

The determination of the position and the correction of the spatial beam position of the laser beams can occur continuously during the operation of the laser exposure device. This allows for the correction of all short and long term drifts of the laser beams, which are particularly the result of thermal changes of the optical components or instabilities of the laser sources themselves. This allows for the use of less expensive, less stable laser sources, and thermal stabilization of the overall structure can be avoided.

The use of thermal actuators for this application is particularly advantageous because in particular when using high-resolution lasers for exposing photographic material, very accurate spatial agreement of the beam positions is required. Such accurate agreements are possible only if the beam positions can be adjusted in infinitesimally small steps. This would not be possible by using simple step motors as actuators, for example. It might be possible to use high-precision piezo actuators as an alternative; however, they require precision high voltage amplifiers and supplies resulting in high costs. The thermal actuators subject to the invention also allow for very precise movements, and thus, exact positioning of the beam positions. The costs of the actuator subject to invention are, however, very low, since it can be realized using simple materials and components and can be controlled easily as well.

Since many of the materials that may be considered for the position-determining actuator elements have a relatively small coefficient of thermal expansion, and for some applications greater movements of the optical elements are required, it is advantageous to use transmission mechanisms for the realization of thermal actuators. One such example is shown in FIG. 2. There, an actuator element 22 with a length that can be changed using a controllable heating element 23, acts upon the optical element 24 to be moved via a mechanical lever. Even a small expansion of the actuator element 22 can lead to a relatively large movement of the optical element corresponding to the length of the lever.

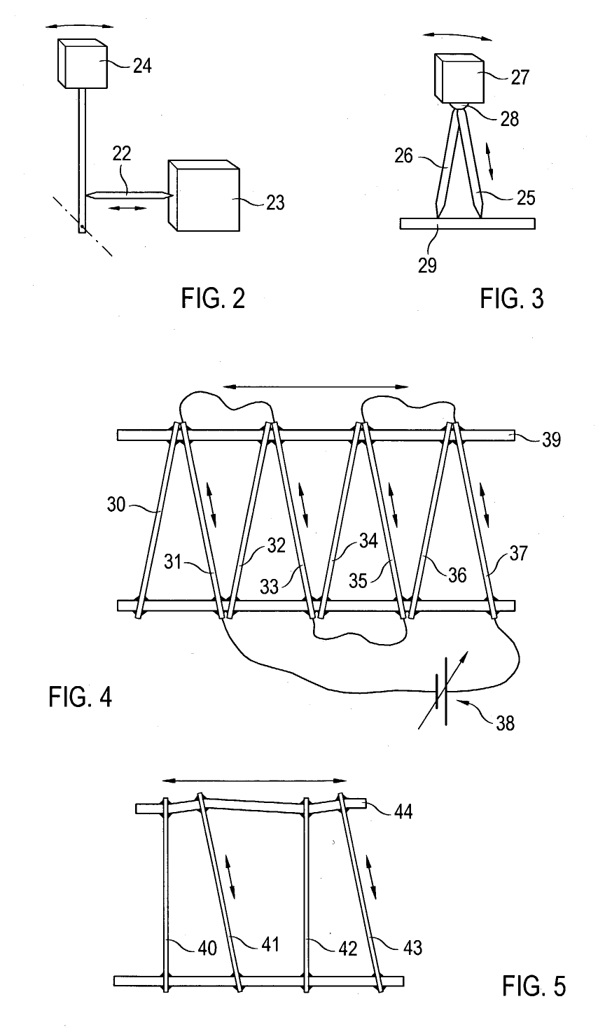

An additional, very simple possibility for realizing a mechanical transmission of movement shown in FIG. 3 consists in arranging a position-determining actuator element 25 and a static actuator element 26 in relation to each other such that the desired direction of movement of the optical element 27 does not occur in the direction of expansion of the elements but instead at a more or less large angle to it. With such an arrangement, it is useful to connect the optical element to the actuator element using a carrier element 28, because this carrier element 28 can be designed as a joint thus allowing for sufficient freedom of movement. Attaching the actuator elements to a base plate 29 increases the stability of the actuator. In this case as well, the position-determining actuator element, which may consist of a steel pin, must, of course, be connected to a controllable heating element, such as a current source (not shown). With such a translation, the achievable movements increase with a decreasing angle between the actuator elements. With very small angles, however, the strength of the actuator element triangle that carries the optical element suffers.

Vibrations of the overall device or similar disturbances cannot be compensated. For this reason, either a compromise must be made between strength and maximum movement when selecting the angle of the triangle or the rigidity of the system must be increased by other means.

A particularly advantageous possibility for increasing the rigidity of the actuator is presented in FIG. 4. It consists in arranging several actuator elements 30-37 parallel to one another. Since one of the parallel arranged elements 31, 33, 35 and 37 is thermally expandable and connected to a power source 38, a group of actuator sub-units comes into existence that transmit a significantly greater force with the same stroke movement and at the same time affect a significantly increased rigidity of the actuator, and thus less sensitive to external disturbances. The movement of the carrier element 39 is achieved by the current-carrying actuator elements 31, 33, 35 and 37 change their expansion corresponding to the current flowing through them and as a result move the static elements 30, 32, 34 and 36 as well as the carrier element 39 in one direction. For example, if the expansion of the current-carrying elements increases, a movement of the carrier element occurs in the direction of the static elements. If the current is decreased, such that the current-carrying elements contract again, a movement of the carrier element 39 occurs in the direction of the current-carrying elements, or in the drawing to the right.

FIG. 5 shows a detailed section of such an actuator sub-arrangement that consists of several actuator elements. When implementing such arrangements, it is generally not possible to build actual triangles using the actuator elements. Rather, oblique trapezoids are formed such as shown in FIG. 5 using the actuator elements 40, 41, 42 and 43, because the position-determining thermally expanding actuator elements 41 and 43 and the static actuator elements 40 and 42 should be arranged at least at a small distance to one another such that they can be fastened and that no heat transfer occurs between the two elements. Generally this is no problem when calculating the movement, however, the carrier plate 44 of the moving optical element must take up greater bending forces. If it has insufficient rigidity, some transmission will be lost, but especially the insufficient rigidity of the carrier plate in use will be transformed down in the selected angle ratio, such that, for example, a lens suspension will tend more to vibrate due to the low plate rigidity. For this reason, the carrier element 44 must exhibit sufficient bending strength.

The stability of such an actuator system can be increased in that a thermal actuator element 45 together with at least two static actuator elements 46 and 47 form an actuator sub-unit for moving the carrier element 48. In this case, the actuator elements are spatially arranged in a three-dimensional fashion, thus forming a tetrahedron. This arrangement allows for greater rigidity and a more accurately defined one-dimensional movement. If, on the other hand, one replaces the static elements 46 and 47 through additional position-determining, thermally expandable actuator elements such as element 45, then the carrier element 48 can carry out any three-dimensional translation within the possible stroke. However, here the possibility exists for a rotation around the spatial axis for the object to be moved. This rotation must be guided sufficiently to allow for a controlled movement of the carrier element, and thus, of the optical elements.

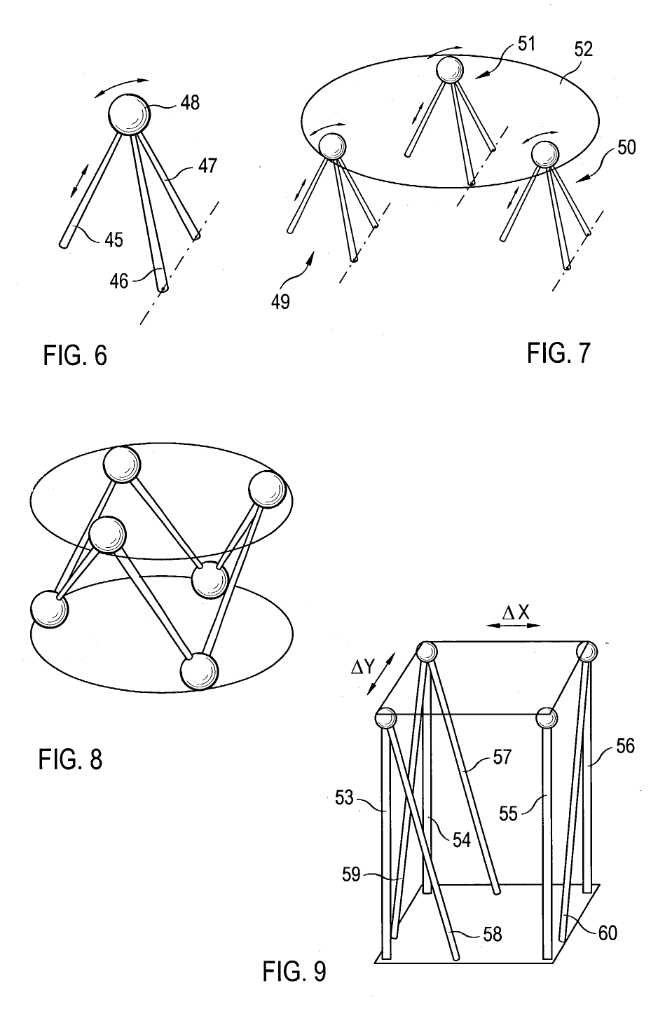

To this end, three tetrahedron actuator sub-units 49, 50 and 51 already known from FIG. 6 are combined as shown in FIG. 7. A carrier element 52 is now supported by these three tetrahedron arrangements. If the three tetrahedron actuator sub-units are each operated parallel to the others, then the carrier element 52 can carry out any desired translation in space, without being able to perform a rotation. If, on the other hand, the tetrahedrons are controlled independent of one another, then the carrier element can additionally perform all rotation movements. Such an arrangement is known by the name hexapod (see FIG. 8).

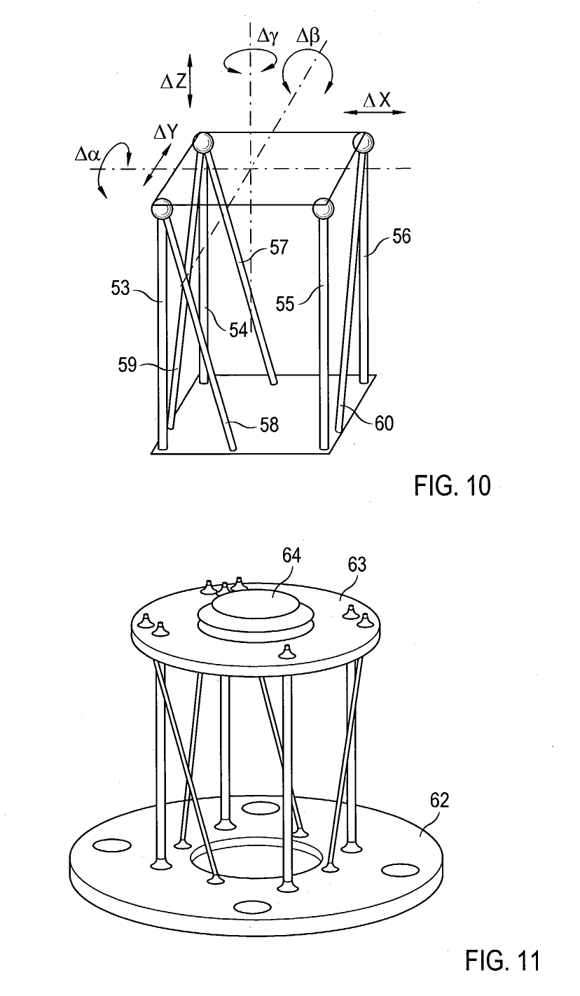

FIG. 9 shows an additional potential arrangement of actuator elements. In this practical exemplary embodiment, eight steel wires are arranged such that they allow for an essentially independent movement in x and y directions (octapod) of a lens attached to the moved plate. The vertical wires 53-56 are selected to be of a much thicker material to achieve a better stability. A varied simultaneous heating up of wires 57 and 58 carries out a movement in the x-direction. The same applies to wires 59 and 60 with regard to the y-direction. Thus, the movements are orthogonalized in comparison to a conventional hexapod, such that the desired direction of movement can be realized without the need for generating complex combination signals.

FIG. 10 shows an additional exemplary embodiment for the actuators subject to the invention. It differs from the arrangement according to FIG. 9 in that the vertical elements are designed as thermally operating actuators. In this manner all three translational and all rotational movements can be carried out. In this manner, through a suitable (and comparatively simple) combination of signals, an orthogonal movement of all degrees of freedom is possible. The generation of the required actuator signals can occur through simple summation (with positive or negative arithmetic sign with the same coefficient of summation each).

If actuation elements employed in such octapod arrangements as shown in FIG. 11 are set between a base plate 62 and a carrier element 63 for an optical element 64 (here a lens), then the lens can be moved in all spatial directions and inclinations and thus deflect beams that are focused by the lens in all directions. Of course, any other optical element, such as a mirror or a telescope can be used in place of the lens. Although the invention has-been described in particular using the exemplary embodiment of a laser exposure device, it can, of course, be employed in all other applications, where stable laser beam positions are required. For example, it can be employed particularly advantageously to couple laser beams into glass fibers, for example, in the field of telecommunication. Applications can also be found in medical technology, where very accurately positioned beams are a prerequisite for the success of laser treatments.

There has thus been shown and described a novel apparatus and method for controlling the spatial beam position of laser beams, and an actuator for this purpose, which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Apparatus for controlling the spatial beam position of laser beams comprising, in combination:
(a) a position detector for determining the current, actual beam position;
(b) a control element for determining a control quantity based on the actual and the desired beam position;
(c) a movable optical element for changing the beam position;
(d) an actuator element, coupled to the optical element, for adjusting the position of the optical element; and
(e) a controllable heating element coupled to the position-adjusting actuator element, for moving the actuator element by means of thermal expansion due to the heating of the actuator element.

2. Apparatus as set forth in claim 1, wherein the heating element comprises a power source for causing the expansion of the position-adjusting actuator element due to current flowing through it.

3. Apparatus as set forth in claim 1, wherein the heating element is connected to the position-adjusting actuator element.

4. Apparatus as set forth in claim 1, further comprising an actuator which includes a carrier for the optical element that is connected to the position-adjusting actuator element.

5. Apparatus as set forth ion claim 4, wherein said carrier also serves as a static actuator element.

6. Apparatus as set forth in claim 4, wherein said actuator further includes a static actuator element.

7. Apparatus device as set forth in claim 6, wherein the position-adjusting and static actuator elements are arranged at angles that are less than 20° with respect to one another.

8. Apparatus as set forth in claim 4, wherein the actuator includes a plurality of position-adjusting actuator elements.

9. Apparatus as set forth in claim 6, wherein the actuator includes a plurality of static actuator elements.

10. Apparatus as set forth in claim 8, wherein the position-adjusting actuator elements are connected to the heating element independently of one another.

11. Apparatus as set forth in claim 8, wherein the position-adjusting actuator elements each have an independent heating element such that each can be adjusted independently of one another.

12. Apparatus as set forth in claim 8, wherein the position-adjusting actuator elements are arranged in a hexapod.

13. Apparatus as set forth in claim 9, wherein the static actuator elements are arranged in a hexapod.

14. In a method for controlling the spatial beam position of a laser beam, wherein the current, actual beam position is determined using a position detector, a control quantity is determined based on the actual and the desired beam position, and the beam position is changed according to the control quantity using an optical element that is moved by an actuator having at least one position-adjusting actuator element, the improvement comprising the step of changing the beam position by controlled thermal expansion of said at least one position-adjusting actuator element.

15. A method as set forth in claim 14, wherein the thermal expansion is controlled by varying an electric current flowing through said at least one actuator element.

16. A method as set forth in claim 14, wherein the thermal expansion is controlled by means of heating elements that are applied to said at least one actuator element with thermal contact.

17. An actuator for moving optical elements for influencing the spatial beam position of laser beams comprising in combination:
(a) a carrier element for optical elements;
(b) at least one position-determining, thermal actuator element that is connected to the carrier element and whose expansion can be changed through heating;
(c) at least one static actuator element that is connected to the carrier element; and
(d) a controllable heating element for heating the position-determining thermal actuator element.

18. An actuator as set forth in claim 17, where position-determining and static actuator elements are arranged at angles of less than 45° to one another.

19. An actuator as set forth in claim 18, where position-determining and static actuator elements are arranged at angles of less than 20° to one another.

20. An actuator as set forth in claim 17, where several position-determining and several static actuator elements are arranged parallel to one another.

21. An actuator as set forth in claim 20, where position-determining actuator elements can be moved independently of one another.

22. An actuator as set forth in claim 20, where the carrier element is supported by three tetrahedron arrangements consisting of position-determining and static actuator elements.

23. An actuator as set forth in claim 20, where the carrier element is supported by a hexapod arrangement consisting of position-determining and static actuator elements.
